(19) United States
(12) Patent Application Publication
(10) Pub. No.: US 2026/0103254 A1
(43) Pub. Date: Apr. 16, 2026

(54) CONSTRUCTION VEHICLE

(71) Applicant: KERN Tunneltechnik SA, Lugano – Paradiso (CH)

(72) Inventor: Reiner Kern, Lugano – Paradiso (CH)

(21) Appl. No.: 18/868,357

(22) PCT Filed: Mar. 28, 2024
(86) PCT No.: PCT/EP2024/058549

§ 371 Date: Nov. 22, 2024

(30) Foreign Application Priority Data
Oct. 19, 2023 (EP) 23204687.0

(51) Int. Cl. B62D 63/02; B60P 1/54; B62D 7/14; B62D 21/18; B62D 27/06; B62D 33/063

(52) U.S. Cl. CPC B62D 63/025; B60P 1/54; B62D 7/142; B62D 21/18; B62D 27/06; B62D 33/0636

(57) ABSTRACT

A construction vehicle includes two drive modules, which are releasably connected to one another, each comprising at least one driven axle, wherein at least one of the two drive modules comprises an axle having steerable wheels. The construction vehicle also includes at least one cab module, which is connectable to each of the two drive modules, and a controller for the two drive modules, which is connected to the at least one cab module. The drive modules comprise a first mechanical connecting arrangement, via which they are connected, and wherein the cab module is connected to any one of the two drive modules via a second mechanical connecting arrangement. Due to its modular design, a construction vehicle of this kind can be adapted in a quite individual manner to a variety of construction site needs.

### BACKGROUND OF THE INVENTION

### 1. Field of the Invention

The present invention relates to a construction vehicle, in particular for tunnel construction, which is suitable for locomotion under narrow and uneven tunnel construction conditions and for serving as a carrier of loads, such as tunnel formwork elements or construction materials.

### SUMMARY OF THE INVENTION

For this purpose, the construction vehicle comprises two releasably connected drive modules, each having at least one driven axle with steerable wheels. Given the narrow conditions in a tunnel, the arrangement of one axle for each drive module will in most cases be sufficient. However, at least one of the drive modules can be multi-axled for nearly completed tunnels and the transport of very heavy loads. It is sufficient for one of the two drive modules to comprise steerable wheels. However, to improve cornering ability and maneuverability, it is preferable for both drive modules to comprise steerable wheels.

The construction vehicle further comprises at least one cab module, which is connectable to each of the two drive modules. The construction vehicle preferably comprises a cab module at each of its two longitudinal ends and, as a result, is able to travel in both directions and be driven from a front cab. Therefore, the conventional terms “forward” and “backward” do not apply to this construction vehicle because it is designed to be largely mirror-symmetrical toward the middle, i.e., about a plane extending transversely to the longitudinal vehicle axis in the middle of the vehicle's length. The construction vehicle further comprises a controller for the two drive modules, which controls both the power for and the steering intensity of the two drive modules, preferably independently of one another. The controller is connected to the at least one cab module, so the vehicle can be operated from the cab module. If cab modules are arranged at both longitudinal ends, then the controller is obviously connected to both cab modules. In this case, a priority circuit is preferably provided which assigns the controller to only one of the two cab modules that is occupied by a driver. However, it is in principle possible for the steering intensity of the assigned drive module to be controlled from the assigned cab, especially when traveling around tight corners, when two persons are necessary for maneuvering, one in the cab located in the direction of forward travel and one in the cab located in the direction of rearward travel. These drivers can then control their steering axles, as well as the lateral and height positions of their cabs, optimally enough that the construction vehicle can travel along the narrowest of cornering radii, e.g. only 5 m. It should be noted at this point that the two drive modules are heavy-duty modules which have a load-carrying capacity of several tons. Preferably, the entire construction vehicle consisting of the two drive modules connected together has a useful load from 20 to 40 tons. Depending on the desired purpose, the two drive modules can be connected together either directly or through a central module. A first connecting arrangement is provided for this connection. A second mechanical connection device is designed for connecting the cab modules to the longitudinal ends of the respective drive module and can be designed to be either identical to the first connecting arrangement, but they may also differ if, for example, the connecting arrangement also comprises hydraulic and electrical coupling arrangements in order to, by way of the connection, simultaneously ensure control of the corresponding drive module via the cab. An electrical and/or hydraulic coupling of this kind can obviously also be achieved by the first mechanical connecting arrangement so that, for example, both drive modules can be steered from the cab of a single cab module.

In principle, it is possible for the two drive modules to be designed identically. However, it is preferable for the two drive modules to perform different functions. For example, an electrical and/or hydraulic supply for the construction vehicle can be arranged in one of the two drive modules and be designed as a service module. More technical drive components can, e.g., then be arranged in the other drive module. A distribution of this kind is advantageous because the corresponding drive systems are sometimes quite large, and distributing the components on both drive modules would complicate the hydraulic and/or electrical supply.

In one advantageous embodiment of the invention, the at least one cab module comprises a support frame having an adjustment mechanism for the horizontal and/or vertical position of a cab of the cab module. The advantage thereby is that both the vertical and lateral cab positions can be adjusted in the cab module. On tight corners, the cab can, for example, be displaced laterally toward the inner radius of the corner so that it does not collide with a construction element bordering the outer radius of the corner. In another respect, the height adjustability of the cab has the advantage of achieving a better overview of the loading and unloading situation, in particular during loading and unloading. The height adjustability of the cab can also improve its ground clearance on a highly undulating substrate, which enables the construction vehicle to also move on very uneven substrates.

The adjustment mechanism for the position of the cab on the cab frame preferably comprises a carriage which is movable on a horizontal guide extending in a direction transverse to the vehicle axis, whereby a height adjustment mechanism is arranged on the carriage and supports the cab in a height-adjustable manner. An adjustment mechanism of this kind is easy to implement and robust, especially under the harsh conditions of tunnel construction, in which a large amount of dust is usually present in the air.

In one advantageous embodiment of the invention, the controller comprises a unit for the coordinated steering of the wheels and for the lateral positioning of the cab according to inputs from a control element arranged in the at least one cab and/or according to distance sensors of the controller. The driver of the construction vehicle can, for example, select the cornering radius as far as a minimum cornering radius via a control element, e.g. a control wheel or joystick, whereby lateral positioning of the cabs also takes place automatically as the cornering radius narrows in order to prevent the cab from hitting objects along the outer cornering radius. Alternatively or additionally, distance sensors or position sensors can also be arranged at the ends of the construction vehicle and be able to ascertain the geometry of the construction site along the direction of travel, therefore being able to autonomously ascertain the cornering radius and, in a basically autonomous manner, adjust the steering angle and the cab position according to the sensor signals. However, these sensors can also be used in a purely assistive manner for the person driving the construction vehicle.

As previously stated hereinabove, each of the two longitudinal ends of the construction vehicle preferably comprises a cab module, so the vehicle can be operated in the same manner-forward or backward-from a front cab. The vehicle then has neither a front nor a rear, and the front and rear are instead determined by the vehicle's direction of travel. The advantage thereby is that, in narrow tunnels where it is impossible to turn the vehicle around, the vehicle can simply be driven out of the tunnel after unloading or loading in the tunnel region via control from the formerly rear cab.

In principle, it is sufficient for one of the two drive modules to comprise steerable wheels. Preferably, however, both drive modules comprise steerable wheels, which significantly improves the minimum cornering radius and the maneuverability of the construction vehicle because the wheels of the wheel axles of both drive modules can be articulated in opposite directions. If both drive modules comprise steerable wheels, then the steering intensity of the wheels of one drive module can preferably be controlled independently of the steering intensity of the wheels of the other drive module. This enables travel along the narrowest of cornering radii given an opposing wheel steering intensity, as well as laterally displaced travel when the wheels of the two drive modules are articulated in the same direction. Therefore, the maneuvering options due to this type of independent control enable use of the construction vehicle in regions where construction vehicles of this size were previously unable to be used.

Preferably, a controller for the steering axes of the two drive modules is arranged in the cab of the at least one cab module so that both steering axes can be controlled from one cab. Under very difficult conditions, it is obviously also possible for the cabs of both end-side cab modules to be occupied, and the vehicle operators to only control the steering axle of their own drive module, which also enables maneuvering in very difficult situations.

In one advantageous embodiment of the invention, the drive modules have an approximately cuboid chassis, the height of which is less than its width and length. Whereas the width of the construction vehicle is preferably between 2 and 4 m, as will be explained later, the length can be varied by means of a central module so that the total length, including the two cab modules, can vary between 8 m and 16 m. The height of the chassis is preferably between 1.50 m and 2.50 m, in particular about 2 m, which makes it possible to place loads on the chassis without the total height, including the loads placed on the chassis, becoming high enough that entry into a tunnel region is no longer possible. In this case, the upper side of the chassis is preferably flat or planar, and the heights of the two drive modules are identical, so that a large, elongated support arrangement is formed by the upper sides of the two drive modules.

Preferably, the first and/or second connecting arrangements are formed by horizontally extending groove/spring connections in the following manner. The grooves are formed by slots, which are formed on the end sides of the main supports of the drive modules, in particular double slots arranged adjacent to one another at a certain vertical extent. The complementary spring elements are formed by two protruding engagement plates arranged next to one another on the end side of the module being connected, e.g. the central module or the cab module, penetrate into the complementary slots on the end sides of the main supports of the drive modules, and are fixed in that location, e.g. by means of locking bolts. The vertical extent of these main supports (preferably, two main supports extending next to one another are installed in the drive module) is preferably higher than their horizontal extent in a direction transverse to the direction of travel, thereby achieving a high degree of stiffness in the load direction of the construction vehicle.

The connecting positions of the groove/spring connections are preferably then achieved by the locking bolts, which penetrate into aligned recesses in the main supports of the drive modules and into the engagement plates of the other modules, thus achieving a rigid connection between the two modules being connected. The overall equipment expenditure can be reduced if the first connecting arrangement and the second connecting arrangement are identical so that all of the modules, i.e. the drive modules, the cab modules, and the additional modules to be specified hereinafter (e.g., lifting modules or crane modules) can ultimately be coupled together in a rigid and fixed manner by means of an identical connecting arrangement.

In one advantageous embodiment of the invention, at least one of the two drive modules comprises separately suspended wheels and/or separately driven wheels. Given a separate suspension and a separate drive for each wheel, i.e. an all-wheel drive of the entire construction vehicle, maneuverability can be significantly improved on uneven substrates and under difficult drive conditions.

The construction vehicle preferably comprises a central module which can be connected between the two drive modules, the central module preferably comprising baseplates for the transport of heavy loads. Therefore, the central module has purely mechanical functions, specifically coupling the two drive modules and providing baseplates for heavy loads. For example, tunnel formwork elements can be placed on this central module. As previously indicated, the construction vehicle has a load capacity of, e.g., 32 tons. It can in particular be provided that the construction vehicle comprises central modules of various lengths, whereby the overall length of the vehicle and clearly also the size of the support surface can be varied. The construction vehicle can therefore be precisely adapted to the specific requirements of tunnel construction or any other type of construction.

In one advantageous embodiment of the invention, the construction vehicle comprises a lifting module having vertical hydraulic support cylinders for connection between the cab module and the drive module. Therefore, given a symmetrical design of the construction vehicle comprising two cab modules, such lifting modules are provided at the two longitudinal ends between the drive modules and the cab modules so that containers or standardized support elements can be accommodated by the hydraulic support cylinders. The lifting module can also be integrated into the cab module.

In a further advantageous embodiment of the invention, the construction vehicle has a crane module comprising at least one hydraulically actuable, swivelable support arm for connection between the cab module on the one hand and the drive module or the lifting module on the other hand. A crane module of this kind can thus be arranged at the two longitudinal ends of the construction vehicle, between the respective drive module and the cab module or lifting module, so that a parallel support arm structure is provided via the two crane modules, which enables the lifting of high and heavy loads. For this purpose, each crane module preferably has laterally extendable stabilization cylinders for stability on the ground in order to prevent the construction vehicle from tipping while picking up the heaviest of loads laterally. The crane module can optionally also be designed to be integral with the lifting module and/or the cab module.

The chassis of the drive modules preferably extend vertically upwards on their end sides facing the central module. The central module preferably then has stiffening struts, which protrude vertically upwards and adjoin the end-side vertical sections of the drive modules, thereby achieving a high degree of stiffness in the load direction (from above).

Needless to say, the construction vehicle can be used not only for tunnel construction, but also for bridge construction and other construction in narrow and impassable conditions.

The following expressions are used interchangeably: Module—drive module, cab module, lifting module, crane module; Vehicle longitudinal axis—direction of travel; First connecting arrangement—second connecting arrangement—connecting arrangement;

It will be clear to the skilled person that the embodiments of the invention described hereinabove can be combined with one another in any desired manner insofar as they do not contradict one another.

### BRIEF DESCRIPTION OF THE DRAWINGS

The invention will be explained hereinafter in greater detail with reference to the schematic drawings attached. Shown are:

FIG. 1 a perspective view of a construction vehicle comprising two drive modules, two cab modules, and a central module for connecting the drive modules,

FIG. 2 an exploded view of the construction vehicle in FIG. 1, with a more detailed illustration of the connecting arrangement between the drive modules and the central module, as well as between the drive modules and the cab modules,

FIG. 3 a side view of the construction vehicle in FIGS. 1 and 2,

FIG. 4 a perspective detail of the second connecting arrangement for attaching the cab module to the drive module, which second connecting arrangement in the exemplary embodiment in FIGS. 1 and 2 is identical to the first connecting arrangement,

FIG. 5 a perspective view of a drive module, from obliquely above the longitudinal end,

FIG. 6 a perspective view of the drive module in FIG. 5, obliquely from below,

FIG. 7 a perspective view of a drive module designed as a service module, obliquely from below,

FIG. 8 an end-side view of the drive module in FIGS. 6 and 7, as seen from the longitudinal end,

FIG. 9 a perspective view of a central module for connecting the two drive modules,

FIG. 10A a side view of a short central module,

FIG. 10B a side view of a long central module for achieving a longer construction vehicle,

FIG. 11 an end-side view of the cab module comprising an integrated lifting module,

FIG. 12 a perspective view of the cab module in FIG. 12, obliquely from the top front,

FIG. 13 a perspective view of the cab module in FIGS. 11 and 12, obliquely from the bottom rear,

FIG. 14 a photograph depicting lateral cab displacement of the construction vehicle in the previous drawings along a tight corner,

FIG. 15 a photograph depicting operation of the lifting modules which are integrated into the cab modules,

FIG. 16 a photograph illustrating the carrying of tunnel formwork elements on the baseplates of the cab module and the central module,

FIG. 17 a photograph depicting one embodiment comprising a swivel crane module on both cab modules, and

FIG. 18 a photograph depicting a rotary crane module on a cab module comprising integrated support hydraulics.

### DESCRIPTION OF THE PREFERRED EMBODIMENTS

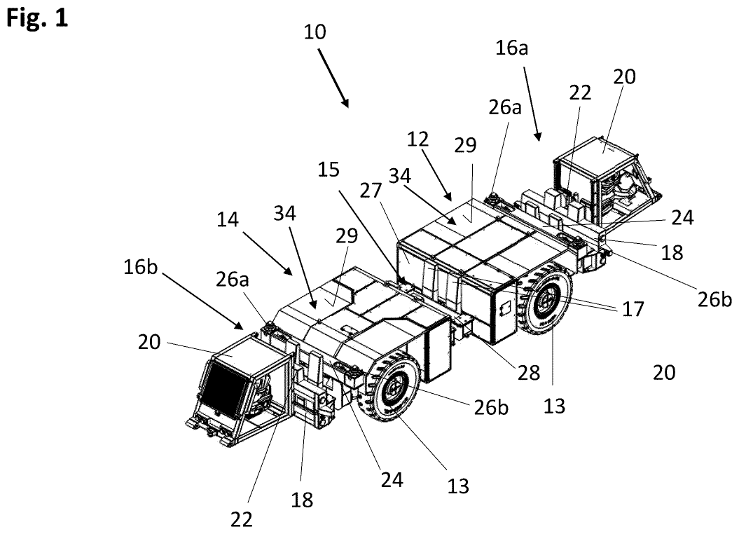

FIGS. 1 to 3 show a construction vehicle 10 consisting of a first drive module 12 and a second drive module 14, which are coupled together via a central module 15. At their longitudinal ends, both drive modules 12, 14 have a cab module 16a, 16b, so that the construction vehicle 10 can drive in both directions and be controlled from the front.

Each of the two drive modules 12, 14 includes a wheel axle comprising separately driven and steerable wheels 13, so the construction vehicle is an all-wheel drive vehicle with two steerable axles which can preferably also be controlled independently of one another. Travel along the smallest of cornering radii or laterally displaced travel is in this way possible if the wheels of both drive modules 12, 14 have the identical steering intensity. However, at least one of the drive modules can also comprise multiple wheel axles.

Each of the two drive modules 12, 14 includes a cuboid chassis 34, the height of which is less than its width and length. The upper side 29 of the chassis 34 of each drive module 12, 14 is thus located at a height of preferably about 2 m, whereas each drive module 12, 14 preferably has a width of between 1.8 m and 3 m and a length of between 2 m and 5 m. Taking the cab modules 16a, 16b into account, this results in an overall vehicle length of between 10 m and 18 m, depending on the length of the central module and how the cab modules are equipped with additional lifting or crane modules.

It is clearly possible to design the two drive modules 12, 14 identically. In the present case, however, the first drive module 12 is designed as a service module and comprises an electrical supply and a hydraulic supply for the construction vehicle 10, whereas other technical drive or control components can, e.g., be arranged in the second drive module 14. Each drive module 12, 14 comprises a wheel axle with steerable wheels 13.

Each cab module 16a, 16b has a cab 20 which is movable along a horizontal carriage guide 18 in a direction transverse to the longitudinal axis of the vehicle, which cab is supported on a carriage of the carriage guide in a height-adjustable manner via a height adjustment mechanism 22, so the cab 20 can be moved laterally as well vertically in relation to the drive modules 12, 14. This enables the construction vehicle 10 to travel along tight corners, or even very rough terrain.

Each cab module 16 a, 16b further comprises an integrated lifting module 24 having two vertical support cylinders 26 a, b on the outside, so that four vertical hydraulic support cylinders 26 a, b are provided on the construction vehicle 10 in a rectangular configuration, by way of which heavy containers or support platforms can be lifted and dropped. The lifting module 24 can also be designed to be separate from the cab module 16 a, b and likewise connected thereto via a first/second connecting arrangement.

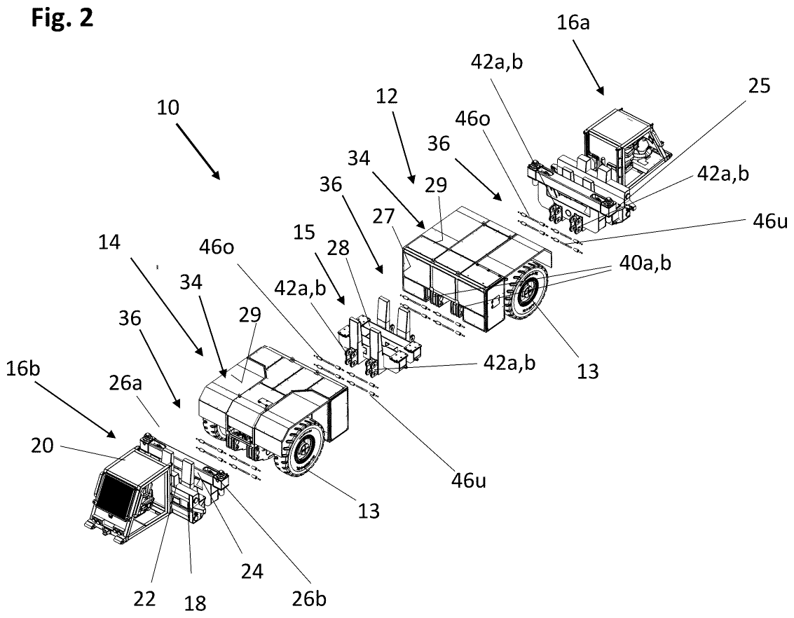

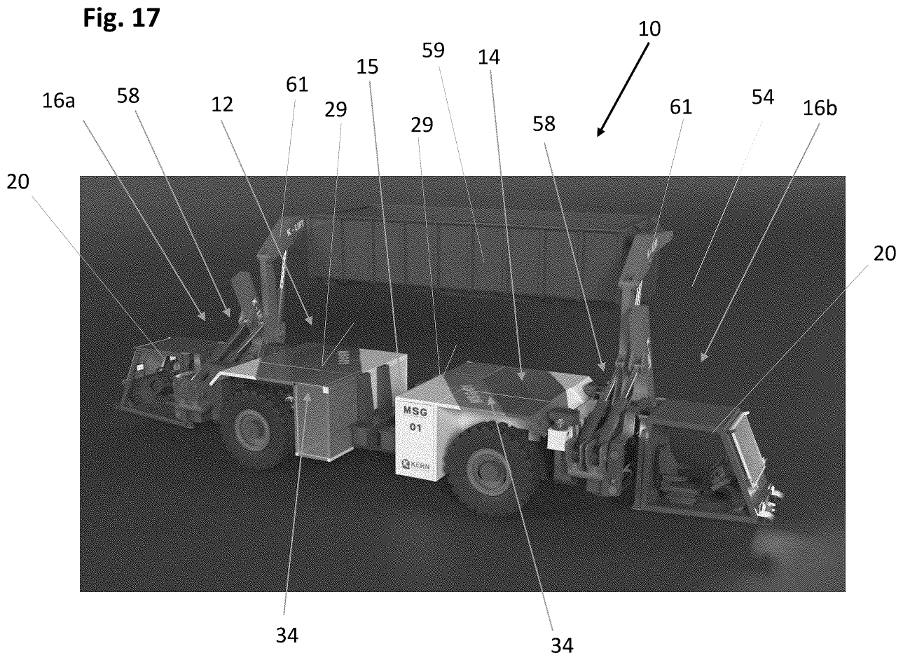

As shown in the exploded view of the construction vehicle in FIG. 2, the central module 15 has baseplates 28 for the placement of heavy loads. In addition, the end sides 27 of the chassis 29 of the drive modules 12, 14 facing the central module 15 extend vertically. On these end sides 27, the central module 15 is supported by stiffening struts 17 which protrude vertically upward, thereby improving the overall stiffness of the construction vehicle 10. By means of the baseplates 28 of the central module, in particular by interacting with the baseplates 25 of the cab modules 16a, 16b, low-lying supports are thus created in order to in particular transport heavy loads in the tunnel region, e.g. formwork elements (FIG. 17). In this context, it should be noted that the baseplates 28 of the central module and the baseplates of the cab modules 16a, 16b are arranged to be significantly lower than the upper side 29 of the chassis 34 of the two drive modules 12, 14, e.g. at a height of about 1 m, so that loads being carried protrude less highly, which is particularly important under narrow tunnel conditions.

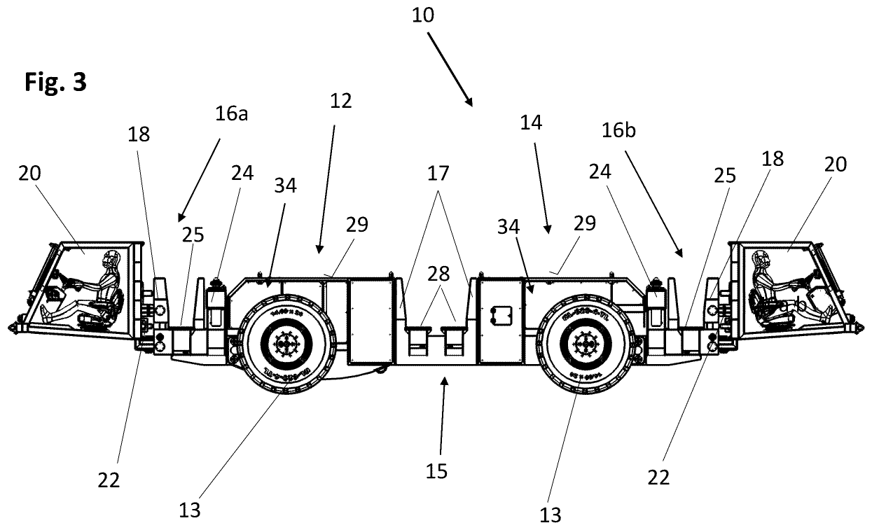

FIG. 3 shows a side view of the construction vehicle according to FIG. 1. As clearly shown, formed in the cab modules 16a, b is a low-level support surface 25, which is between the horizontal sled 22 and the lifting module 24 and is located at the same height as the baseplates 28 of the central module 15. A very low support is in this way formed for formwork parts and other components being transported, whereby the loaded parts will not result in an excessive overall height of the construction vehicle 10.

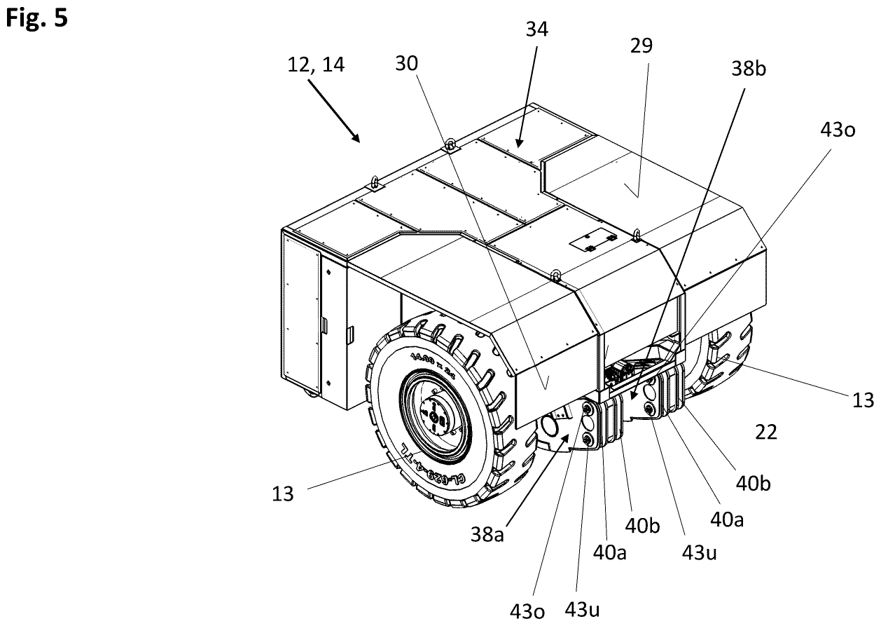

As is also clearly shown in FIG. 3, end-side vertical support struts 17 are provided on the central module 15 and adjoin the vertical end walls 27 (which face one another) of the two drive modules 12, 14, thus ensuring a high level of stiffness and torsional stiffness, even when high loads are being supported. FIG. 5 illustrates these components once again in an exploded view.

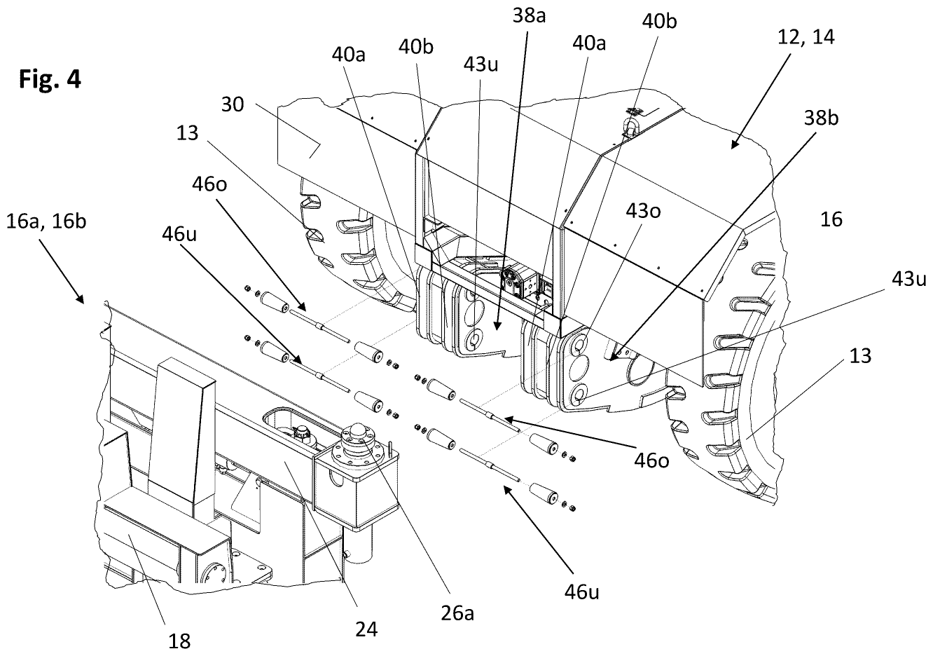

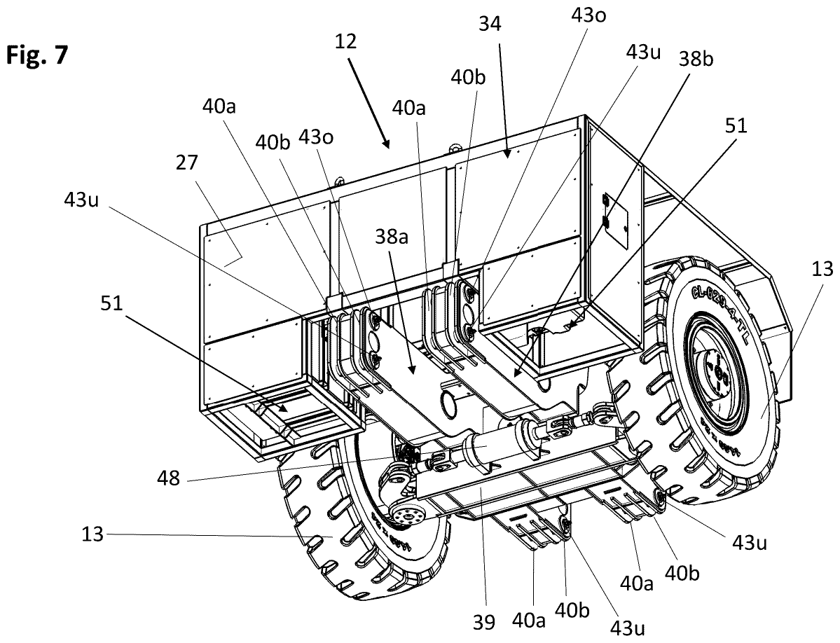

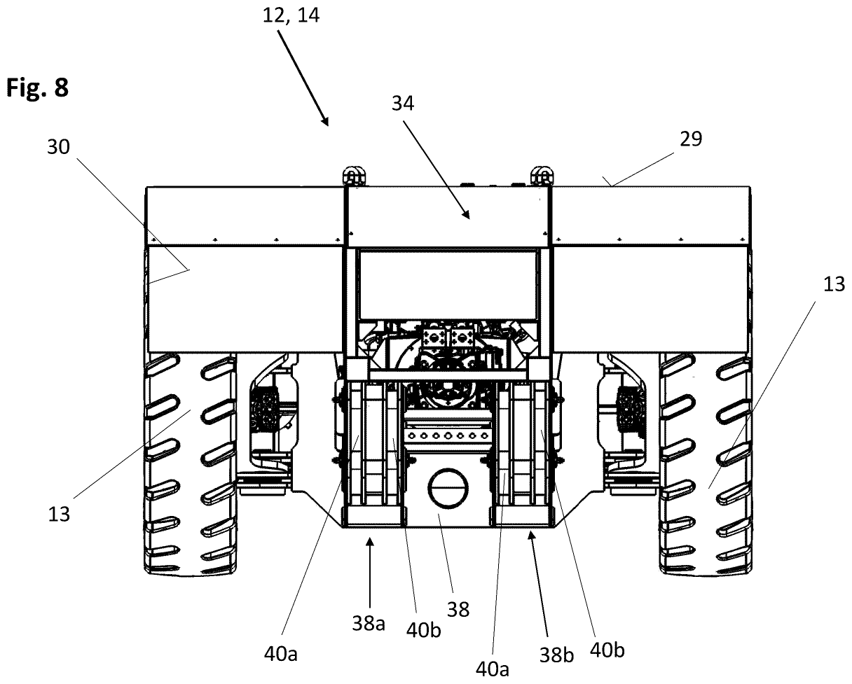

More clearly shown in FIGS. 2 and 4 is the connecting arrangement 36 between the drive modules 12, 14, the cab modules 16a, 16b, and the central module 15. Each drive module 12, 14 has two longitudinal supports 38a, 38b (see in particular FIGS. 7 and 8), which are arranged next to one another and are connected together via the support strut 39 of the wheels 13, thereby forming the main support and thus the support frame of the drive modules 12, 14. These two longitudinal supports 38a, 38b extend from the inner end side 27 to the outer end side 30 of the drive modules 12, 14.

The end sides of the longitudinal supports 38a, 38b have two horizontal slots 40a, 40b, which are arranged next to one another and extend in the longitudinal direction of the vehicle. The slots 40a, 40b are therefore open on the end sides of the longitudinal supports 38a, 38, thus serving as a groove for the connecting arrangement 36, which is designed as a groove/spring arrangement.

On the opposite side, the central module 15 and the two cab modules 16a, 16b each have two protruding engagement plates 42a, 42b on their sides opposite the slots, which plates fit and engage into the slots 40a, 40b on the ends of the longitudinal supports 38a, 38b in an interlocking manner. A fixed and rigid mechanical connection is in this way achieved between the drive modules 12, 14 on the one hand and the central module 15 or the cab module 16a, 16b on the other hand.

In the connecting position, the engagement plates 42a, 42b are almost completely accommodated in the slots 40a, 40b. This connecting position of the mechanical connecting arrangement 36 is then secured for each longitudinal support 38a, 38b by means of an upper locking pin 460 and a lower locking pin 46u. In the connecting position, these two locking pins 46o, 46u penetrate the aligned upper and lower horizontal recesses 43o, 43u in the longitudinal supports, as well as corresponding recesses 44o, 44u in the engagement plates 42a, 42b. Both recesses 43o, 43u in the longitudinal supports 38a, 38b and recesses 44o, 44u in the engagement plates 42a, 42b are aligned in the connecting position and can then be penetrated by the two securing pins 46o, 46u, as a result of which the connecting arrangement 36 is then in a secured connecting position.

FIG. 4 shows the design for the first connecting arrangement 36 between the drive module 12, 14 and the cab module 16a, 16b, which first connecting arrangement is in this exemplary embodiment designed to be identical to the second connecting arrangement 36 between the drive module 12, 14 and the central module 15.

FIG. 5 shows a perspective view of the outer end side 30 of a drive module 12, 14 comprising the associated parts of the connecting arrangement 36, specifically the central supports 38a, 38b of the drive modules 12, 14 (which supports each comprise two slots 40a, 40b for connection to the cab module 16a, b), as well as the upper and lower horizontal recesses 43o, 43u in the longitudinal supports for the locking pins 46o, 46u (FIG. 4) for the connecting position of the connecting arrangement 36. Also shown is the design for the drive modules 12, 14 comprising a cuboid chassis 34 which (in a dust-and debris-proof manner) surrounds all of the the essential elements, specifically drive elements, hydraulic and electrical elements 49, or the electrical and hydraulic supply 51 for the drive module 12, 14, whereby the chassis 33 forms a planar surface 29 which is at a relatively low height, so that transported loads can be transported at a very low height level, which is necessary under confined tunnel construction conditions.

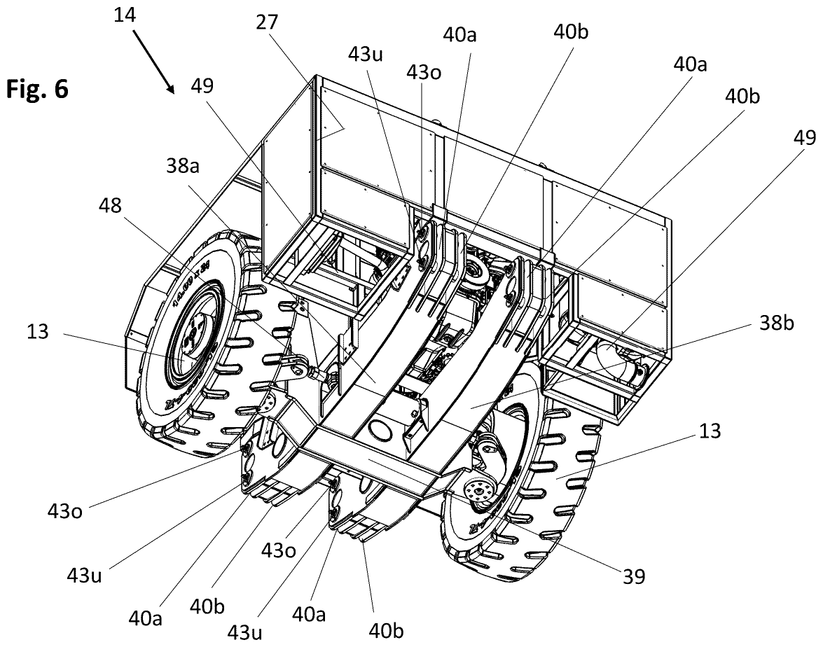

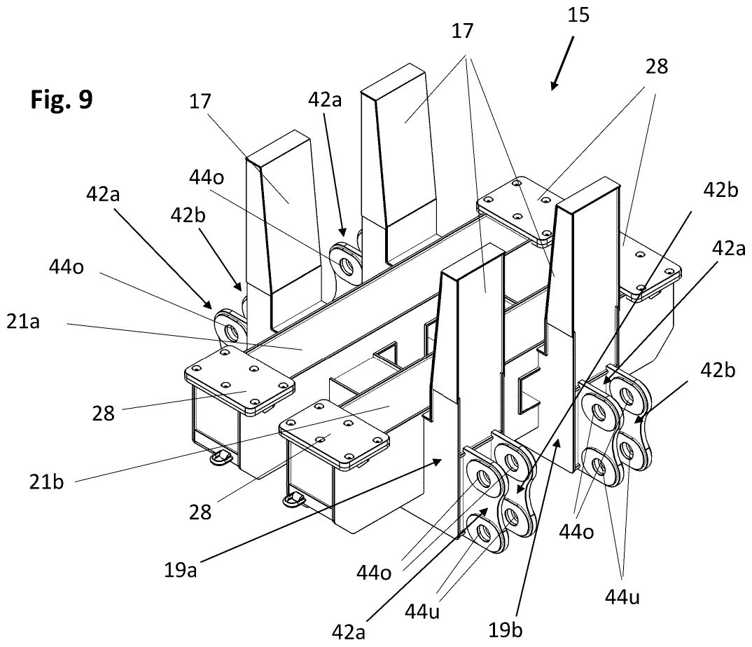

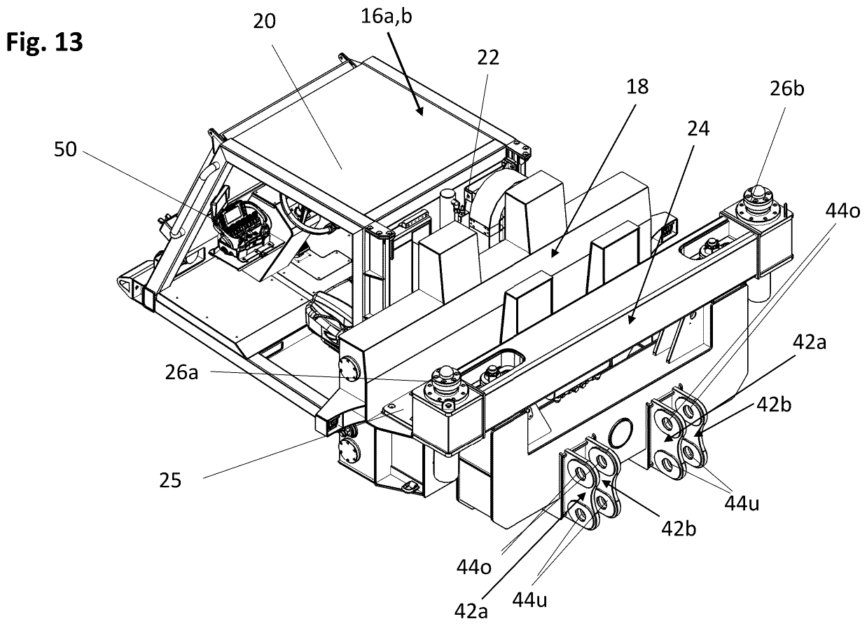

FIG. 6 shows a perspective view of the first drive module 12, obliquely from below and specifically from the center of the end side 27. As clearly shown, the longitudinal supports 38a, b extend over the entire length of the drive module 12, 14, thus protruding toward both end sides 27, 30 of the drive module 12, 14. The two longitudinal supports 38a, 38b are connected together via a support strut 39 for the wheels 13. Arranged on each of the longitudinal ends of the longitudinal supports 38a, 38b are two slots 40a, 40b for the engagement plates 42a, 42b of the cab modules 16a, 16b (FIG. 13) and the central module 15 (FIG. 9). The two wheels 13 are steerable via a corresponding steering mechanism 48. The chassis 34 provides space for accommodating technical drive and control components 49.

FIG. 7 is a similar perspective view, obliquely from below, of the second drive module 14, which also comprises a steering mechanism 48 for the two wheels 13, this second drive module 14 being designed as a service unit which, in a debris-proof manner, accommodates the electrical and hydraulic supply 51 for the construction vehicle in the chassis 34.

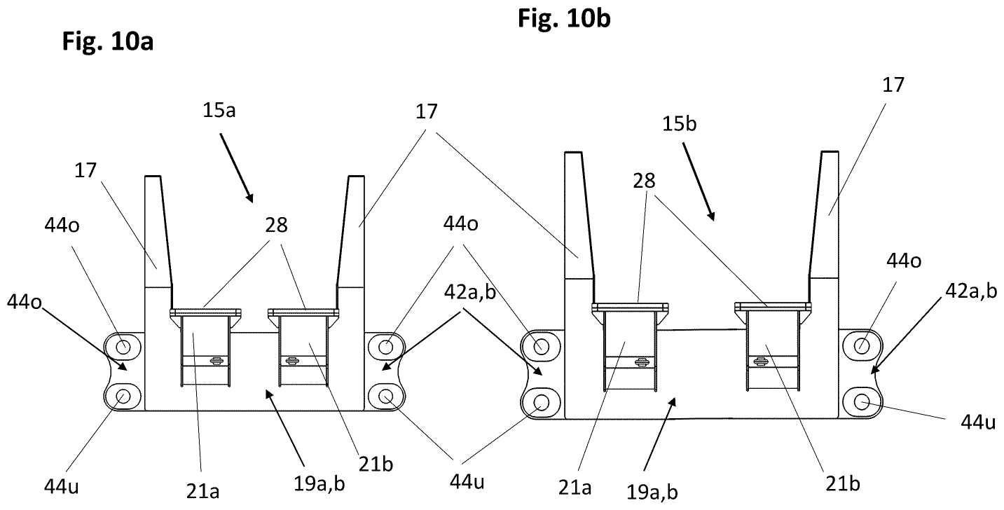

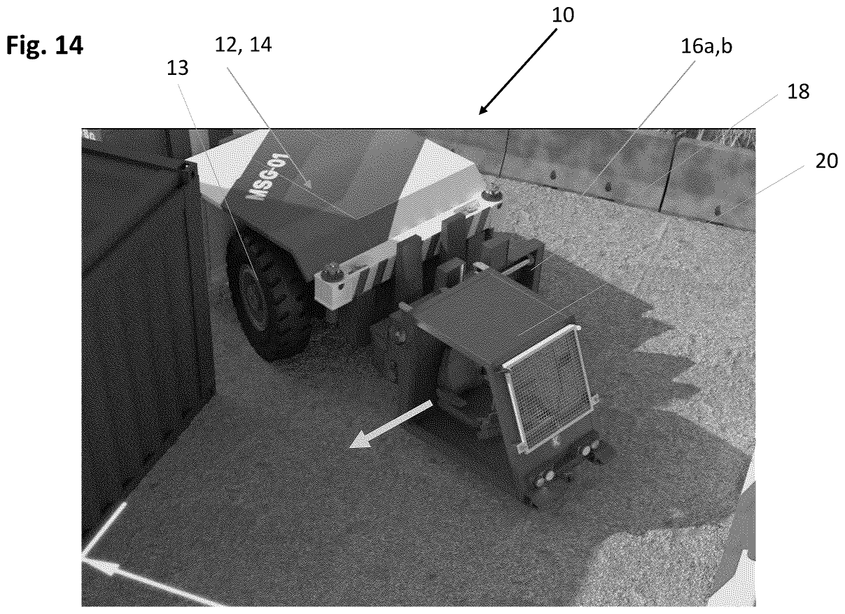

FIG. 8 shows an end-side view of a drive module 12, 14 comprising the portion of the connecting arrangement 36 that is on the drive module side and is formed by the slots 40a, 40b, which are formed by protruding engagement plates 42a, b of the central module 15 (FIG. 10) or the cab module 16a, b (FIG. 14) and are secured in their interlocked connecting position by means of the locking bolts 46o, 46u.

FIG. 9 shows the basic structure of the central module 15. The central module consists of two longitudinal supports 19a, 19b, which extend in the longitudinal direction of the construction vehicle and are aligned with the longitudinal rails 38a, 38b of the drive modules 12, 14. Respectively arranged on the two end sides of the main supports 19a, 19b are two protruding engagement plates 42a, 42b, which act as a portion of the connecting arrangement 36 on the central module side and, in the connecting position of the connecting arrangement 36, penetrate the slots 40a, 40b of the drive modules on both end sides. This connecting position is secured by means of locking bolts 46o, 46u (FIG. 4), which penetrate the aligned recesses 43o, 43u of the drive modules 12, 14 and the corresponding recesses 44o, 44u of the central module or the cab module.

FIG. 10a and FIG. 10b show two different central modules 15a, 15b with different lengths for the main beams 19a, 19b so that, depending on the loads being transported, a longer wheelbase results between the two drive modules 12, 14, and a different overall length of the construction vehicle 10 thereby.

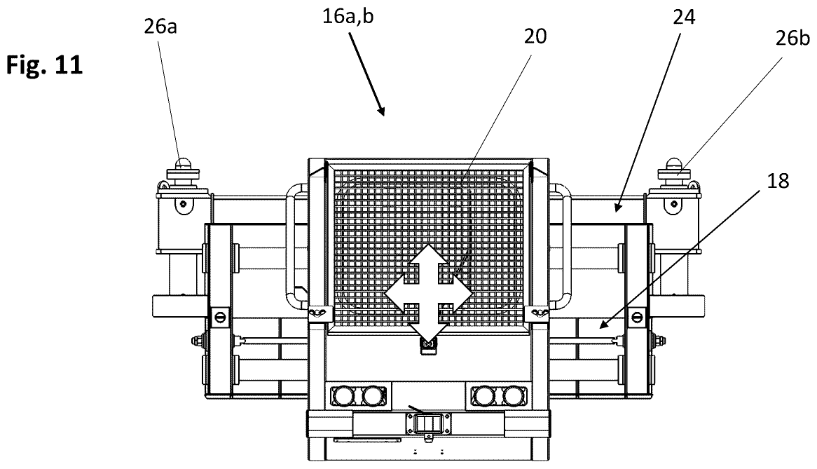

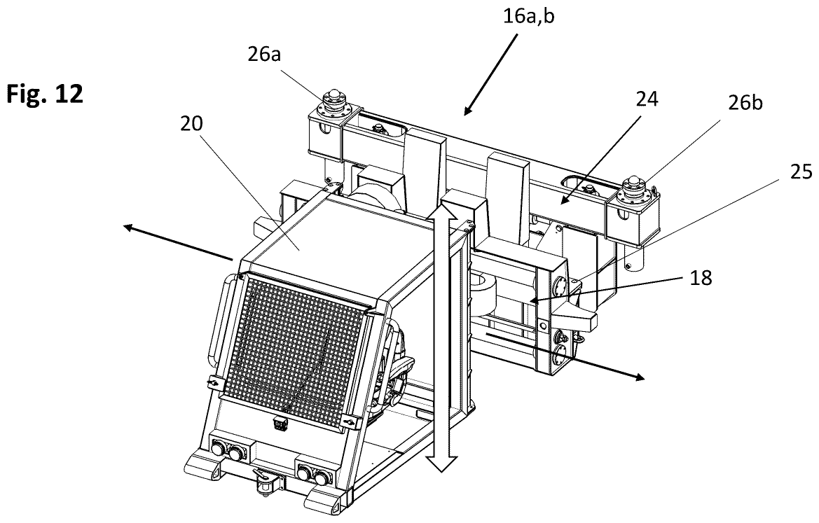

FIGS. 11, 12, and 13 Show the Cab Modules 16a, 16b in Greater Detail.

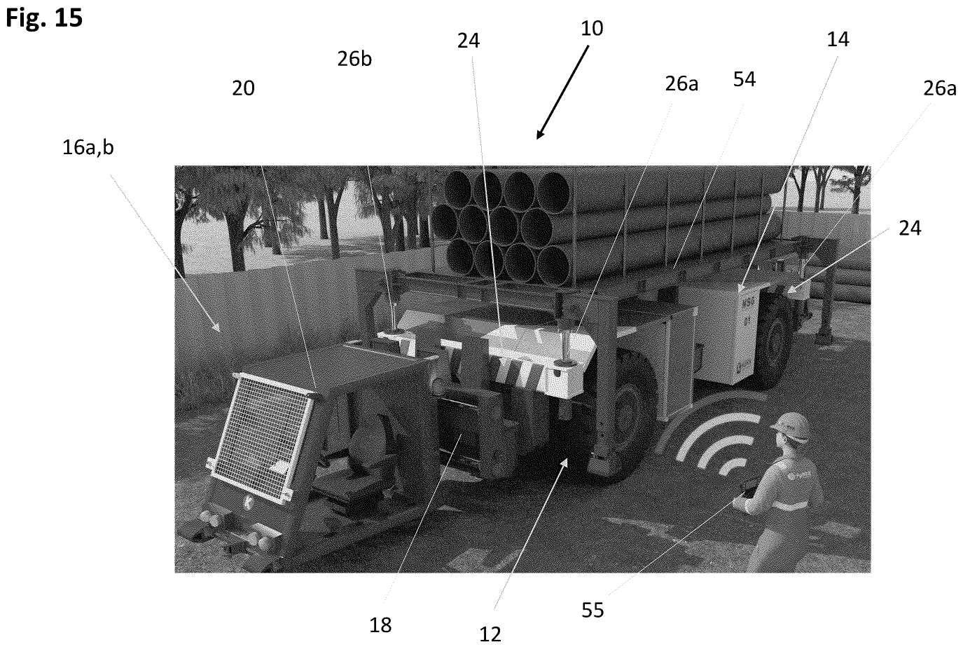

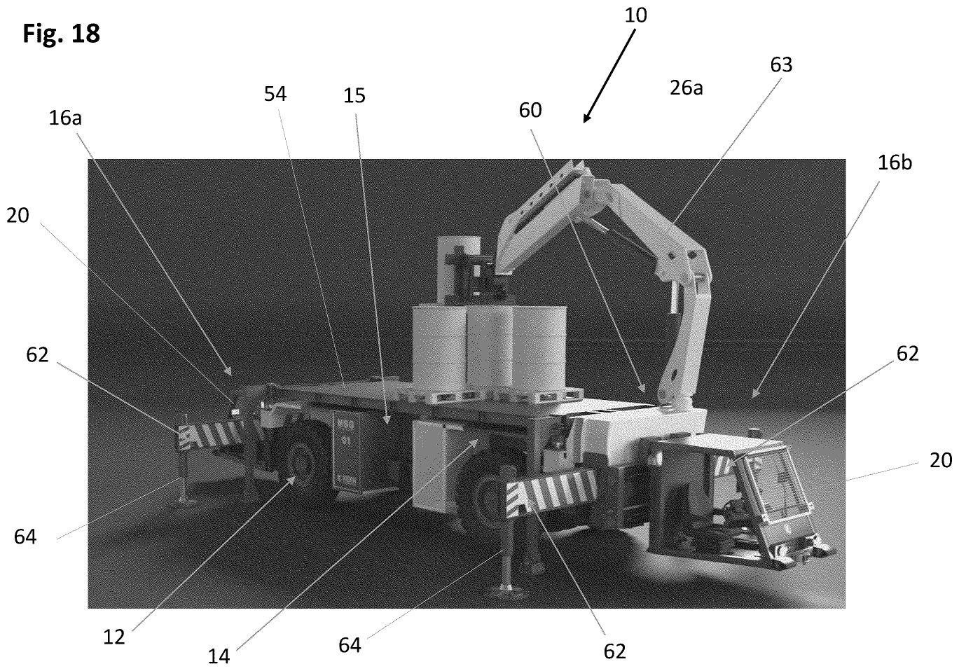

The directional arrow rectangle in FIG. 11 indicates that the cab 20 is adjustable on the horizontal carriage guide 18 and via the height adjustment mechanism 22 (FIG. 13) both laterally, i.e. transverse to the direction of travel of the construction vehicle 10, as well as vertically. FIG. 13 also shows a control wheel 50 and foot pedals 52 for operating the engine of the drive modules 12, 14 (which is preferably designed as a heavy diesel drive) and for steering the drive modules 12, 14. In principle, both drive modules 12, 14 can comprise their own drive or, alternatively, only one of the two drive modules 12, 14 has a drive motor and couples drive energy into the second drive module via a shaft. Also clearly shown in FIGS. 11 to 13 is the design of the lifting module 24, which consists of a support structure extending in a direction transverse to the longitudinal axis of the vehicle. Arranged on both longitudinal ends of said structure are vertical support cylinders 26a, b so that, given two cab modules 16a, 16b, a total of four of these support cylinders 26a, 26b are formed at the two ends of the construction vehicle 10 and are able to lift containers and heavy support platforms (FIGS. 15 and 18). In this context, it should be noted that the lifting module 24 can also be designed as a separate module which is connectable to the cab module 16a, 16b via the connecting arrangement 36 in the same manner as a drive module 12, 14. In this case, a slot arrangement 40a, 40b (as shown in FIGS. 4 to 8) must be provided on the other side of the lifting module 24, at the ends of the longitudinal supports 38a, 38b of the drive modules 12, 14.

The photograph in FIG. 14 shows the lateral displacement (see arrow) of the cab 20 along the horizontal carriage guide 18 on the inner radius of a tight corner, which significantly reduces the cornering radius of the construction vehicle.

FIG. 15 shows the operation of the vertical support cylinders 26a, 26b for lifting and lowering heavy loads, in this case a support frame for construction materials. The operation of the vertical support cylinders 26a, 26b can be controlled via a remote controller 55, possibly even when the engine of the construction vehicle 10 is switched off.

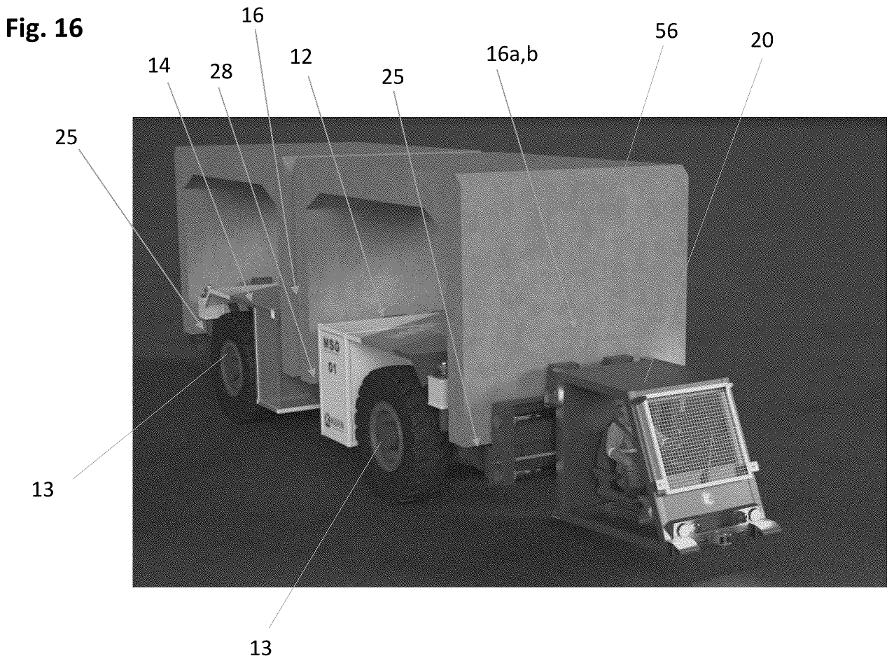

FIG. 16 shows the importance of the low-lying baseplates 25 of the cab modules 28 and of the central module for transporting tunnel formwork elements 56. Due to the low baseplates 25, 28, the tunnel formwork elements will not protrude as high, which may be critical to the accessibility of a lower tunnel region.

FIG. 17 shows a swivel crane module 58, which is arranged on the cab module 16a, 16b between the lifting module 24 and the horizontal carriage guide 24. In this case, a swivel crane module 58 comprising a swivel arm 61 that is swivelable in a direction transverse to the longitudinal axis of the vehicle is arranged on each cab module 16a, 16b so that, by means of the swivel arms 61 of the two swivel crane modules 58 on both sides of the drive modules 12, 14, heavy loads (e.g., a construction container 59 on the upper sides 29 of the chassis 34 of the drive modules 12, 14) can be lifted and, starting from the latter location, lowered and set down.

Alternatively, as shown in FIG. 18, a rotary crane module 60 which includes a rotatable, multi-member lifting arm 63 and a stabilizing apparatus 62 comprising vertical support cylinders 64 can also be arranged on each cab module 16a, 16b or (in the embodiment shown) on only one cab module 16b, or between the cab module 16a, 16b and the drive module 12, 14. By means of the rotary crane module 60, loads from both sides of the construction vehicle 10 can be lifted, either onto the upper side 29 of the chassis 34 of the drive modules 12, 14, or onto a support frame 54 for construction material, which is supported on the vertical support cylinders 26a, 26b of the lifting modules 24.

The invention is not limited to the exemplary embodiment shown, but can instead be varied within the protective scope of the attached claims. In this context, it should again be noted that the cab module 16a, 16b can comprise both the lifting module 24 and the swivel crane module 58 and/or the rotary crane module 60 in an integrated manner, optionally comprising a lateral stabilization apparatus 62. However, these modules 24, 58, 60 can also be designed to be separate from the cab module 16a, 16b and may be connected to the drive modules 12, 14 via the connecting arrangement 36. The modular system for the construction vehicle 10 of the present invention enables a highly individualized assembly of the construction vehicle, depending on the requirements prevailing in the tunnel or at the construction site, thus providing a customized solution for all emerging requirements.

### LIST OF REFERENCE SIGNS

10 Construction vehicle
12 First drive module
13 Wheels of the drive modules
14 Second drive module
15 Central module for connecting the two drive modules
16a, b Cab modules
17 Vertical stiffening struts of the central module for adjoinment on the vertical end sides of the drive modules
18 Horizontal carriage guide, transverse to the direction of travel
19a, b Main support of the central module
20 Vehicle cab
21a, b Transverse support of the central module for bearing the baseplates
22 Height adjustment mechanism for the vehicle cab, on the carriage of the carriage guide
24 Lifting module comprising two vertical hydraulic support cylinders, possibly integral with the cab module
25 Support surface for loads on the cab module, between the lifting module and the horizontal carriage
26a, b Vertical hydraulic support cylinder of the lifting module
27 Vertical end sides of the chassis of the drive module, facing one another
28 Support plates for loads on the central module
29 Upper side of the chassis of the drive module
34 Chassis of the drive module
36 Connection arrangement between the modules in the manner of a groove/spring system
38a, b Two central, longitudinal supports of the drive modules, which supports extend to both end sides
39 Support strut for the wheels, which connects the longitudinal supports and by means of which the main support of the drive modules is formed
40a, b Slots at both ends of the longitudinal supports of the drive modules, acting as a groove portion of the connecting arrangement
42a, b Protruding engagement plates on both end sides facing away from the central module and on one end side of the cab module, intended for engagement into the slots
43o, u Upper and lower recesses in the ends of the longitudinal supports, oriented horizontally and transverse to the longitudinal axis of the vehicle
44o, u Upper and lower recesses in the engagement plates, which recesses are aligned with the recesses in the longitudinal supports when in the connecting position
46o, u Upper and lower locking pins for penetrating the upper or lower recesses
48 Steering mechanism for the wheels of the construction vehicle
49 Technical drive and control components in one of the two drive modules of the
50 Control device in the cab, connected to the controller of the construction vehicle, in this case a steering wheel or joystick
51 Electrical and hydraulic supply for the construction vehicle
52 Control device in the cab, connected to the controller of the construction vehicle, in this case foot pedals
54 Support frame for construction material
55 Remote control for the lifting module, and/or the swivel crane module or the rotary crane module
56 Tunnel formwork elements
58 Laterally swiveling swivel crane module
59 Construction container
60 Rotary crane module
61 Swivel arm of the swivel crane module
62 Laterally extendable hydraulic stabilization apparatus of the swivel crane module or the rotary crane module
63 Rotatable multi-member support arm of the rotary crane module
64 Vertical hydraulic support cylinders of the stabilization apparatus

1. A construction vehicle, comprises:
two drive modules, which are releasably connected to one another, each comprising at least one driven axle, wherein at least one of the two drive modules comprises an axle having steerable wheels,
at least one cab module which is connectable to each of the two drive modules, and
a controller for the two drive modules which is connected to the at least one cab module,
wherein the drive modules comprise a first mechanical connecting arrangement, via which they are connected, and wherein the cab module is connected to any one of the two drive modules via a second mechanical connecting arrangement.

2. The construction vehicle according to claim 1, wherein one of the drive modules is designed as a service module, which comprises an electrical and/or hydraulic supply means for the construction vehicle

3. The construction vehicle according to claim 1, wherein a cab of the at least one cab module is laterally supported in a movable manner thereon, in particular in that the cab module comprises a horizontal carriage guide (18) for the horizontal position of the cab of the cab module.

4. The construction vehicle according to claim 3, wherein the cab is supported on the cab module in a height-adjustable manner, in particular by means of a height adjustment mechanism on the horizontal carriage guide of the cab unit.

5. The construction vehicle according to claim 3, wherein the controller comprises a unit for the coordinated steering of the wheels and the lateral positioning of the cab according to the inputs from a control element arranged in the at least one cab and/or according to distance sensors of the controller.

6. The construction vehicle according to claim 1, wherein the two longitudinal ends of the vehicle each comprise a respective cab module.

7. The construction vehicle according to claim 1, wherein both drive modules comprise steerable wheels, and the steering intensity of the wheels of one drive module can preferably be controlled independently of the steering intensity of the wheels of the other drive module.

8. The construction vehicle according to claim 1, wherein at least one control unit for the steering axles of the two drive modules is arranged in the cab of the at least one cab module.

9. The construction vehicle according to claim 1, characterized in that the drive modules comprise a chassis which is approximately cuboid in shape and has a height that is less than its width and length.

10. The construction vehicle according to claim 9, wherein the upper side of the chassis is flat, and the heights of the two drive modules are identical.

11. The construction vehicle according to claim 1, wherein the first and/or second connecting arrangement for connecting the modules is/are formed by interlocking connections of the groove or spring type.

12. The construction vehicle according to claim 11, wherein the connecting arrangement on the drive modules comprises end-side slots in particular on the longitudinal support of said arrangement, which are penetrated by protruding engagement plates on the cab module or central module in a connecting position.

13. The construction vehicle according to claim 12, wherein the connecting position is secured by locking bolts.

14. The construction vehicle according to claim 1, wherein the first connecting arrangement and the second connecting arrangement are identical.

15. The construction vehicle according to claim 1, wherein at least one of the two drive modules comprises separately suspended wheels and/or separately driven wheels

16. The construction vehicle according to claim 1, wherein the vehicle comprises a central module that connects the two drive modules which central module preferably comprises baseplates for the transport of heavy loads.

17. The construction vehicle according to claim 16, wherein the vehicle comprises multiple central modules of varying length, which are alternately connectable to the drive modules in order to change the overall length of the construction vehicle.

18. The construction vehicle according to claim 1, wherein the vehicle comprises a lifting module having vertical hydraulic support cylinders for connection between the cab module and the drive module.

19. The construction vehicle according to claim 18, wherein the lifting module is designed to be integrated into the cab module.

20. The construction vehicle according to claim 1, wherein the vehicle comprises a crane module having at least one hydraulically swivelable support arm for connection between the cab module on the one hand and the drive module or the lifting module on the other hand, wherein the crane module can be designed to be integral with the cab module.

21. The construction vehicle according to claim 20, wherein the crane module comprises a laterally extendable stabilization apparatus for stability on the ground.
